(19) United States
(12) Patent Application Publication
(10) Pub. No.: US 2013/0268229 A1
(43) Pub. Date: Oct. 10, 2013

(54) METHOD FOR FINDING FAULT-TO-FAILURE SIGNATURES USING ORDERED HEALTH STATES

(71) Applicants: William J. Gleeson, III, Tucson, AZ (US); Robert S. Wagoner, Tucson, AZ (US); Neil W. Kunst, Tucson, AZ (US)

(72) Inventors: William J. Gleeson, III, Tucson, AZ (US); Robert S. Wagoner, Tucson, AZ (US); Neil W. Kunst, Tucson, AZ (US)

(73) Assignee: Ridgetop Group, Inc.

(21) Appl. No.: 13/439,487

(22) Filed: Apr. 4, 2012

(51) Int. Cl. G06F 19/00

(52) U.S. Cl. 702/108

(57) ABSTRACT

A method is proposed for finding Fault-to-Failure signatures using ordered health states. A data matrix including reference values for a healthy device and degraded values for different degradation levels is processed to determine which data parameters, and more particularly which data parameter time windows, vary from the reference values both with an “order” and a “separation” consistent with ordered health states. The time sample at which a minimum gap between ordered health states is a maximum may determine the window end point. The window start point may be determined by walking back from the end point to the time sample at which the minimum gap crosses a threshold. In this manner, the time window starts when an acceptable order among the health states is first attained and ends when the separation is the strongest.

### GOVERNMENT RIGHTS

This invention was made with United States Government support under Contract Number N68335-07-C-0237 with the Naval Air Warfare Center Ad (LKE). The United States Government has certain rights in this invention.

### BACKGROUND OF THE INVENTION

1. Field of the Invention

This invention relates to methods for finding fault-to-failure (FTF) signatures among available data parameters that can be used to assess the state of health (SoH) and remaining useful life (RUL) of fielded devices.

2. Description of the Related Art

Fault-to-Failure (FTF) signatures are useful for devices that perform some electrical or mechanical function. These devices, including individual devices or assemblies thereof, will degrade over time and eventually fail. A FTF signature based on readily available data parameters allows the current state of health (SoH) of the device to be assessed and the remaining useful life (RUL) to be predicted.

As part of the standard testing and characterization of a class of devices, a number of sample devices (i.e. units under test (UUTs) are subjected to a test sequence that suitably controls the device to emulate all aspects of its standard operations and to emulate conditions that may stress the device. When operating, the

UUT outputs values for one or more data parameters. A “healthy” device is subjected to multiple test runs of the test sequence during which the data parameter values are recorded at a given sampling rate. The data parameter values are averaged to provide baseline reference values of a healthy device at each sample time in the test sequence. Thereafter, a physical degradation control parameter such as a resistance or capacitance is degraded from its baseline value to intentionally degrade the performance of the device. The degraded device is subjected to multiple test runs of the test sequence during which the data parameters are recorded at the given sampling rate. The data parameters values are averaged to provide degraded values at each sample time in the test sequence. This is repeated for multiple degradation levels to fill a “data matrix” with the reference values and degraded values at each degradation level.

Existing techniques to find a FTF signature from the data matrix use classical statistical tools such as computing means, medians, variances and other weighted differences between the degraded values and the reference values to identify the data parameter(s) that best reflects degradation in the health state of the device. These techniques may segment the test sequence into fixed, possibly overlapping, windows in order to identify a particular time window of a data parameter that best reflects degradation of the device. The FTF signature will typically include a data parameter ID, the time window ID, the references values for the data parameter for every time sample in the time window and a health state metric (corresponding to each degradation level). A typical health state metric is the distance between the degraded and reference values over the window.

The FTF signature is stored and provided with fielded devices. During field operations, the device will on occasion be subjected to the test sequence. Data parameter values are recorded during the time window and the health state metric is calculated based on those values and the reference values. The value of the metric is compared to the stored values for the different health states to assess the current SoH of the device. RUL can be estimated based on a history of SoH assessments.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a method for finding Fault-to-Failure signatures using ordered health states. The method finds both the data parameter and particular time window of the data parameter within the test sequence that are consistent with ordered health states.

In an embodiment, the data matrix is processed taking into account the fact that the matrix data comes from ordered health states to determine which data parameters, and more particularly which windows of data parameters, vary from the reference values both with an “order” and a “separation” consistent with ordered health states. The resulting FTF signature suitably includes the start and end points of a time window of a data parameter in which the health states are ordered and well separated. The FTF signature may include more than one such time window of the same or different data parameter.

In an embodiment, a processor processes the data matrix to compute time-averaged health state metrics based on the differences between the degraded values and reference values and compute gaps between the time-averaged ordered health state metrics (e.g. 1-2, 2-3, 3-4, etc.) as a function of the time sample for each data parameter. The processor determines one or more time windows of one or more data parameters in which the gaps are consistent with ordered health states (e.g. all gaps are positive). In different embodiments, a fixed-length moving average or a variable-length integration filter may be used to process the reference and degraded values to compute the time-average health state metrics. For additional noise reduction, the gaps may be subjected to similar filtering.

In an embodiment, the processor computes the minimum gap at each time sample based on the gaps. The process selects the time sample at which the minimum gap is a maximum to determine the end point. Depending on the construction of the time-averaging filter, the end point may be offset by a known amount. The processor walks back from the end point to select the first time sample at which the minimum gap crosses a threshold in the positive going direction as the start point. In different embodiments, the start and end point of the final FFT signature may be adjusted. For example, a fixed-length time window may be selected from the time window in which the gaps are most consistent with ordered health states. Alternately, the time window may be overlapped with the test sequence and the start/end points adjusted to align with the known timing of one or more sub-sequences in the test sequence.

In an embodiment, the processor may select one or more data parameter time windows based on a combination of criteria. One such criteria being the minimum gap between the ordered health states. Another criteria may be a minimum window duration. Another criteria may be a consistency of the data parameter over the entire test sequence with ordered health states. This, for example, may be indicated by a percentage of the time samples where the minimum gap is above the threshold.

In an embodiment, the processor declares a reference value for each time sample as that value that minimizes a maximum error between the declared reference value and the recorded reference values given three or more test runs.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a plot of an idealized health state metric versus time illustrating ordered health states for an exemplary UUT test sequence subject to different degradation levels;

FIG. 2 is a plot of time-averaged health state metrics for recorded data and a plot illustrating the use of gaps between ordered health states to determine starting and ending points of candidate FTF signatures;

FIG. 3 is a block diagram of a system for testing a UUT to select a FTF signature for a class of devices;

FIG. 4 is an embodiment for determining reference values for the data matrix given three or more test runs;

FIG. 5 is a flow diagram of an embodiment for selecting a data parameter time window that is consistent with ordered health states;

FIG. 6 is a flow diagram of an embodiment using a fixed-length moving average filter for selecting a data parameter time window that is consistent with ordered health states; and

FIG. 7 is a flow diagram of an embodiment using a variable-length integration filter for selecting a data parameter time window that is consistent with ordered health states.

### DETAILED DESCRIPTION OF THE INVENTION

The present invention provides a method for finding Fault-to-Failure signatures using ordered health states.

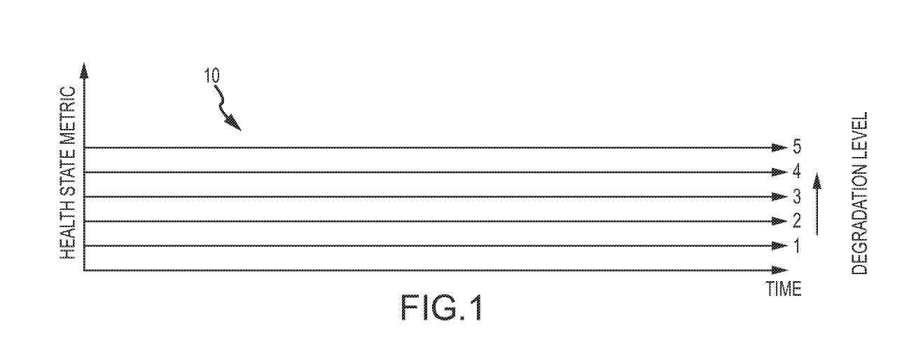

The principles underlying the use of ordered health states to find a Fault-to-Failure signature are illustrated in FIG. 1, which plots a health state metric 10 as a function of time for different degradation levels of a device. The health state metric 10 is suitably the distance between recorded values for a given data parameter at a specified degradation level and the reference values at each time sample from the data matrix. The methodology assumes that the data (e.g. recorded data parameter values) is recorded with known ordered health states. The methodology further assumes that at some time in the test sequence (1) the health state metric for a healthy device is approximately zero, (2) the health state metric for a degraded device is non-zero and (3) the health state metric increases with the amount of degradation. It follows that the health state metric at each degradation level defines a “health state” e.g. degradation level 1 maps to health state 1 and so forth. These health states are “ordered” in the sense that the health state metric 10 for each successive health state increases in value as its distance from the healthy state increases.

A good Fault-to-Failure signature is defined as one in which both the “order” of the health states for different degradation levels and the “separation” of those health levels is maintained. In the idealized case depicted in FIG. 1, the health state metrics 10, hence the health states, remain well ordered and well separated throughout the entire sequence for all of data parameters. In this idealized case, the designer can select any time window of any data parameter and realize a good FTF signature. Unfortunately the data matrix for actual test sequences applied to real devices (UUTs) does not yield ideal results.

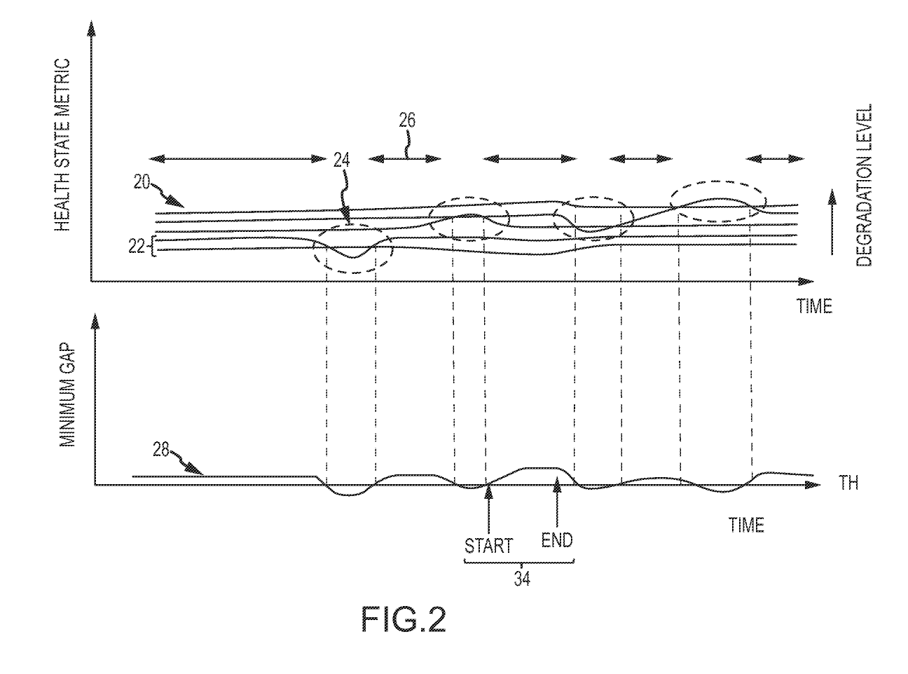

FIG. 2 plots an exemplary health state metric 20 for different degradation levels of a UUT for a class of devices over a time sequence for a data parameter. With real data, a time-averaging filter is used to reduce noise. The filter may, for example, comprise a fixed-length moving average filter or a variable-length integration filter. “Gaps” 22 between the ordered health states are equal to the signed distance between their associated health state metrics; gap 1 is the distance between health state 1 and health state 2, gap 2 is the distance between health state 2 and health state 3 and so forth. A filter may be applied to the “gaps” to further reduce noise. This filter may be a fixed-length moving average filter or a variable-length integration filter.

Even with this noise filtering, the health state metrics may from time-to-time vary in a manner that is inconsistent with ordered health states (e.g. the value for health state metric 2 is less than the value for health state metric 1 such that gap 1 is negative). Dashed circles 24 indicate time windows in which the health state metrics are inconsistent with ordered health states. Double-headed arrows 26 indicate time windows in which the health state metrics are consistent with ordered health states. The test sequence typically includes multiple sub-sequences that exercise different performance characteristics of the UUT. The different sub-sequences may control inputs to the UUT differently or to differently degrees to exercise different modes of operation. For some sub-sequences the different degradation levels of the control parameter may have little or no effect on the data parameters. The separation and perhaps order of the health states may be compromised during these sub-sequences. Conversely for other sub-sequences the different degradation levels may have a substantial effect on one or more of the data parameters. The order of the health states may be compromised at other seemingly random times due to complex interactions between how the UUT is being controlled and various parameters of the UUT.

Our methodology processes the data matrix to determine which data parameters, and more particularly which data parameter time windows, vary from the reference values both with an “order” and a “separation” consistent with ordered health states. The methodology uses the “gaps”, and more particularly the minimum gap, to determine the time sample at which the separation between ordered health states is robust e.g. a maximum and declares that time sample as the end point of a time window. The methodology uses the “gaps”, and more particularly the minimum gap, to determine the first time sample preceding the end point at which the separation crosses a minimum threshold in a positive going direction.

In an exemplary embodiment the methodology tracks the minimum gap 28 at each time sample. The time sample at which the minimum gap 28 attains its maximum value is declared as the window end point 30. The window start point 32 is determined by walking back from the end point 30 to the time sample at which the minimum gap crosses a threshold (TH) 34 in the positive going direction. In this manner, the time window 36 starts when an acceptable order among the health states is first attained and ends when the separation of the ordered health states is the most robust.

Our methodology allows the data that emanates from ordered health states to find the natural boundaries of the FTF signature that is most consistent with ordered health states. Our methodology does not constrain a priori the possible boundaries of the time windows. By comparison, a conventional approach for finding the FFT might segment the health state metrics 20 into fixed overlapping windows and select the window having the largest variance among the health state metrics. The FTF signature found by our methodology differs in three ways. First, our methodology allows the data to determine the start and end points of the window; the window is not a priori fixed in width and location in time. Second, our methodology enforces order among the health states during the window. A classic variance calculation does not. Third, our methodology enforces a minimum separation between all health states. A classic variance calculation does not.

One of ordinary skill in the art will appreciate that different embodiments of our methodology may be implemented to find Fault-to-Failure signatures using ordered health states without departing from the scope of the present invention. The methodology may set the threshold at zero, or at a small positive value to force the data to achieve a certain minimum order before starting a window. The methodology may adjust the end/start points to compensate for a known offset produced by the time-averaging filters, to select a fixed-length time window that is most consistent with ordered health states or to correlate the window to the known timing of sub-sequences within the test sequence.

The methodology may select one or more data parameter time windows based on a combination of criteria. One such criteria being the maximum minimum gap. Another criteria may be a minimum window duration. Another criteria may be a consistency of the data parameter over the entire test sequence with ordered health states. This, for example, may be indicated by a percentage of the time samples in the test sequence where the minimum gap is above the threshold. The methodology may choose the time window having the maximum minimum gap from the data parameter having the highest percentage of ordered time samples.

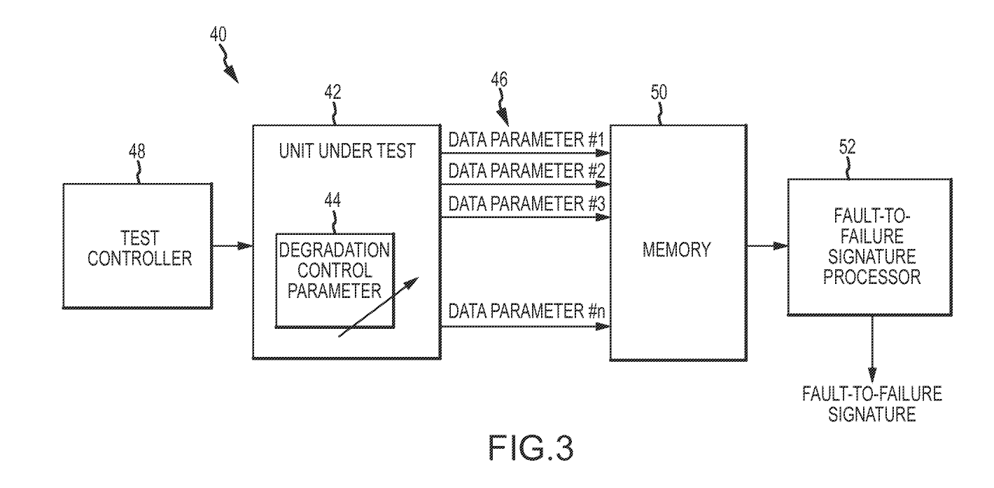

Referring now to FIG. 3, an exemplary test station 40 for performing a test sequence on a unit under test (UUT) 42 for a class of devices to find and store a Fault-to-Failure signature for that class of devices. UUT 42 comprises a sample device from a class of devices or an assembly including a sample device. The UUT includes at least one degradation control parameter 44 that can be set to different degradation levels from a baseline level for a healthy device to progressively higher levels of degradation. This parameter may be, for example, a resistance, a capacitance a thermal conductance in the device. When operating, the UUT outputs values for one or more data parameters 46. These data parameters are readily available both in the test environment and in a fielded environment. The data parameters 46 may be outputs of the sample device itself or of other components in the assembly.

A test controller 48 controls UUT 42 to perform the test sequence. Test controller 48 includes any sources (e.g. analog voltage or current sources, digital controllers etc.) that are required to drive the UUT and any controllers that are required to control the various sources to execute the test sequence. The data parameter values output by the UUT at each time sample in the test sequence are stored in memory 50. Test controller 48 performs one or more test runs of the test sequence with the UUT 42 set at its baseline degradation and multiple degradation levels to populate a data matrix in memory 50. A Fault-to-Failure processor 52 processes the data matrix to find and record a FTF signature for the class of devices. The FTF signature includes at least a data parameter ID, start and end points of a time window, reference values for the data parameter for each time sample in the data window and values of a health state metric for each of a plurality of ordered health states.

In an embodiment, the population of the data matrix is accomplished in the same manner as that used by known techniques to find FTF signatures; the difference lying in how that data is processed to find the FTF signatures.

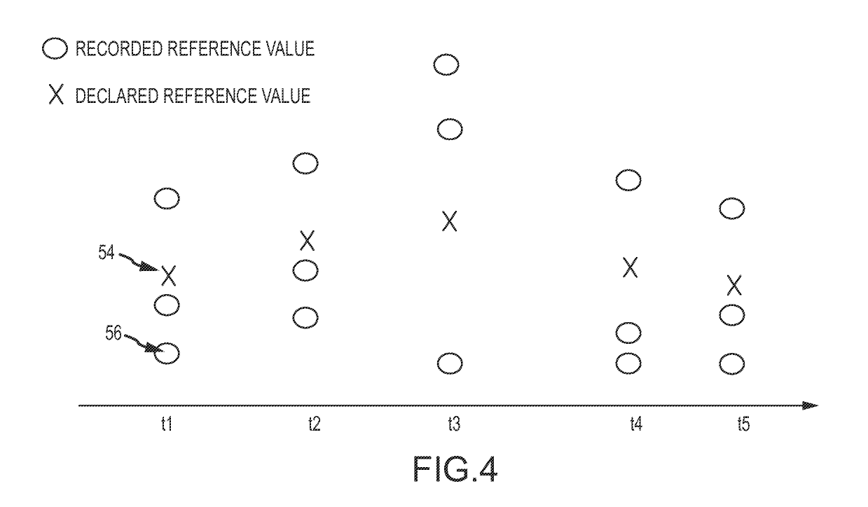

In another embodiment, the population of the data matrix is modified as regards declaring the reference value for each time sample for a given data parameter. The standard approach is to average the reference values recorded for the multiple test runs. As shown in FIG. 4, an alternate approach is for the FTF signature processor 52 to declares a reference value 54 for each time sample as that value that minimizes a maximum error between the declared reference value 54 and the recorded reference values 56 given three or more test runs. Although causation is unknown, empirical testing has demonstrated that declaration of the reference values 54 in this manner provides more robust FTF signatures.

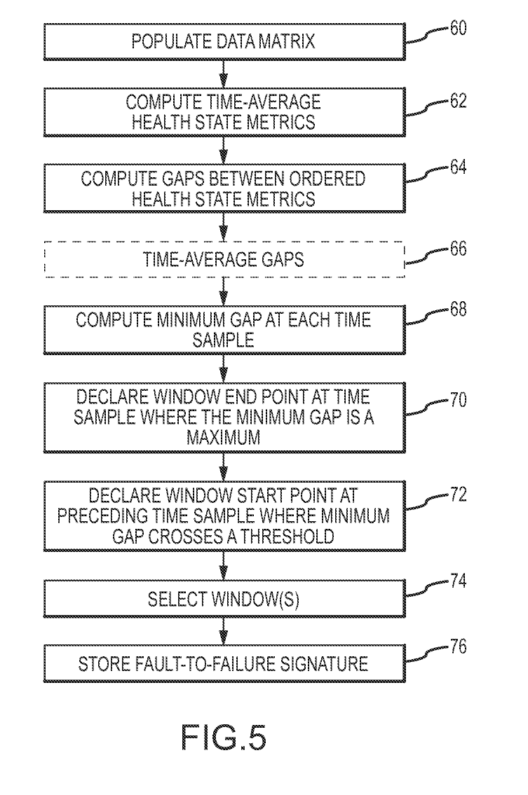

FIG. 5 illustrates an embodiment of a flow diagram for finding a Fault-to-Failure signature using the test system. The first step 60 is to populate the data matrix as previously described. The FTF processor processes data from the data matrix to compute time-averaged health state metrics HSM1(tᵢ), HSM2(tᵢ) . . . as a function of time sample tᵢ for each of the ordered health states for each data parameter (step 62). The health state metrics represent a distance between the degraded value and reference value at each time sample averaged over time to reduce measurement noise. The time-averaging may be performed with a fixed-length moving average filter or a variable-length integration filter for example. The FTF processor computes gaps GAP₁₂, GAP₂₃ . . . between ordered health state metrics HSM1(tᵢ) and HSM2(tᵢ), HSM3(tᵢ) and HSM4(tᵢ) . . . (step 64). The FTF process may time-average the gaps to further reduce noise (step 66). The FTF processor computes and stores the minimum gap for each time sample (step 68).

For at least one time window of at least one of the data parameters, the processor declares a window end point at the time sample (tᵢ) where the minimum gap is the maximum (step 70). Thus the end point marks the time sample at which the separation between health states is the most robust and the most consistent with ordered health states. If configured to select more than one time window from a data parameter, the processor may select the time samples having the N largest minimum gaps as the end points of N different time windows where N is fixed. Alternately, the process may select as end points any N samples whose minimum gaps satisfy a separation criteria where N is variable. The separation criteria could be a fixed threshold or a variable threshold referenced off of the maximum value of the minimum gap. For each declared end point, the processor declares a window start point as the first time sample preceding the end point where the minimum gap crosses a threshold in a positive going direction (step 72). In this manner, the time window 36 starts when an acceptable minimum order among the health states is first attained and ends when the separation of the ordered health states is the most robust.

In general, the method may be configured to find one or more time windows from one or more data parameters and to select one or more time windows from amongst those time windows (step 74) to store as the Fault-to-Failure signature (step 76). In one configuration, the method selects the one window having the maximum minimum gap from among all the data parameters. In another configuration, the method first finds the window having the maximum minimum gap for each of the data parameters and the selects the most robust data parameter. One criteria for selecting the most robust data parameter would be to select the data parameter having the highest percentage of time samples where the minimum gap exceeds the threshold. In another configuration, the method may select the N windows having the largest minimum gap. Alternately, the method may select one window from each of N data parameters having the largest minimum gaps.

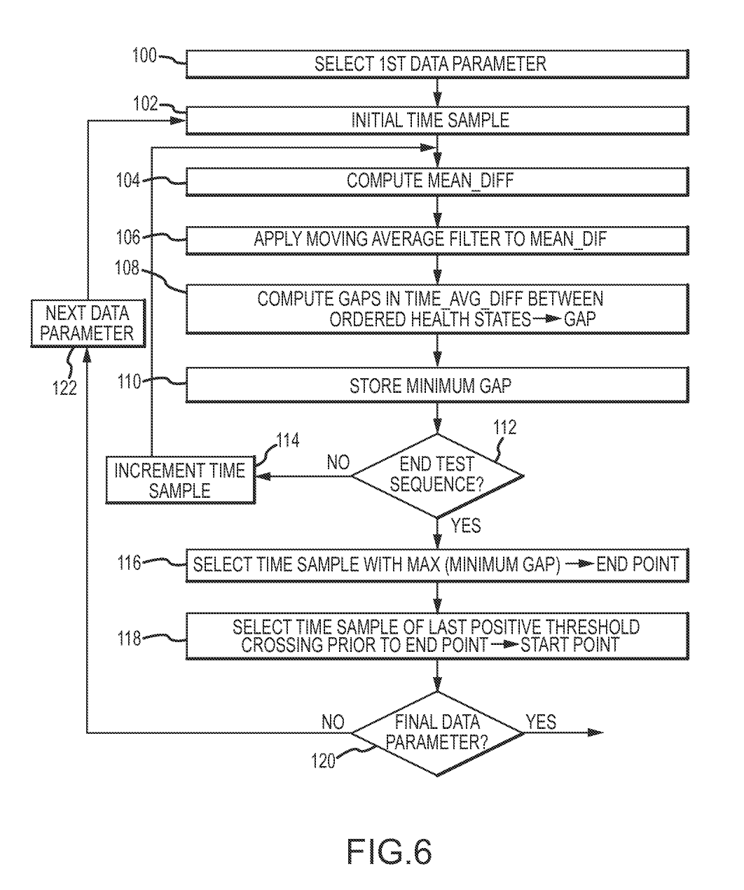

FIG. 6 is a flow diagram for an embodiment in which a fixed-length moving average filter is used to compute the time-averaged health state metrics and find a time window for each data parameter. The processor selects a first data parameter from the data matrix (step 100) and the data for the initial time sample in the test sequence (step 102). Assuming there is data for multiple test runs, the processor computes a mean difference (mean_diff) between the degraded values and the reference values for the current time sample (step 104). The processor applies a fixed-length moving average filter to the mean differences in a neighborhood of the current time sample to compute time-averaged differences (time_avg_diff) (step 106). The moving average filter may be leading, lagging or centered on the current time sample. The process computes gaps between the time-averaged differences for the ordered health states (step 108) and stores the minimum gap for the current time sample (step 110). The processor determines whether the end of the test sequence has been reached (step 112) and if not increments the time sample (step 114) and repeats steps 104, 106 and 108 until it reaches the end of the test sequence.

Once a minimum gap has been assigned to every time sample for a data parameter, the processor selects the time sample with the maximum minimum gap as the end point (step 116). Depending on whether the filter is a leading, lagging or centered filter, the end point may be offset by a known amount from the selected time sample. The processor selects the time sample of the last positive going threshold crossing that precedes the end point as the start point (step 118).

The processor determines whether the final data parameter has been reached (step 120) and if not, retrieves the data for the next data parameter (step 122) starting at the initial time sample (step 102) and repeats the process to find a time window for each data parameter in which the data is the most consistent with ordered health states.

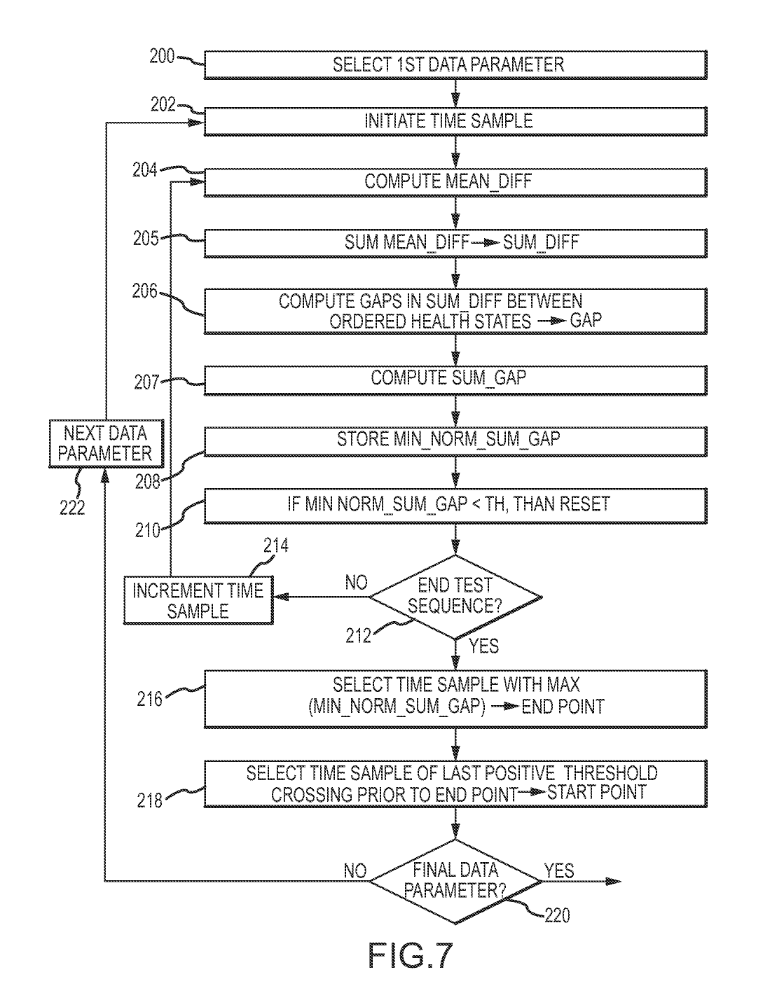

FIG. 7 is a flow diagram for an embodiment in which a variable-length integration filter is used to compute the time-averaged health state metrics and find a time window for each data parameter. The processor selects a first data parameter from the data matrix (step 200) and the data for the initial time sample in the test sequence (step 202). Assuming there is data for multiple test runs, the processor computes a mean difference (mean_diff) between the degraded values and the reference values for the current time sample (step 204). The processor computes a running sum of the mean differences from the initial time sample (or last reset) as sum_diff (step 205). The process computes gaps between the sum_diff for the ordered health states (step 206) and (optionally) computes a running sum of the gaps from the initial time sample (or last reset) as sum_gap to provide additional noise filter (step 207). The processor computes and stores a minimum normalized sum gap for each time sample (step 208). The process first selects the minimum sum gap at the time sample and than divides that value by the number of samples in the running sum since the initial time sample (or last reset). If the minimum normalized sum gap is less than a threshold, the processor declares a “reset” of the integration (step 210). A “reset” resets the sum_diff and sum_gap values to zero to restart the integration at the next time sample. The processor determines whether the end of the test sequence has been reached (step 212) and if not, increments the time sample (step 214) and repeats steps 204-208 until it reaches the end of the test sequence.

Once a normalized minimum sum gap has been assigned to every time sample for a data parameter, the processor selects the time sample with the maximum normalized minimum sum gap as the end point (step 216). The processor selects the time sample of the last positive going threshold crossing that precedes the end point as the start point (step 218).

The processor determines whether the final data parameter has been reached (step 220) and if not, retrieves the data for the next data parameter (step 222) starting at the initial time sample (step 202) and repeats the process to find a time window for each data parameter in which the data is the most consistent with ordered health states.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A method for finding a fault-to-failure (FTF) signature for a unit under test (UUT), comprising:
generating a data matrix by repeating a test sequence with the UUT, said UUT having a degradation control parameter set to a baseline value and then to different degradation levels to generate time samples of one or more data parameters to establish reference values of a healthy UUT and degraded values for a plurality of ordered health states;
for each data parameter, determining with a processor a time-averaged health state metric based on differences between the degraded and references values for each said ordered health state; and
determining with a processor a time window for a data parameter wherein gaps between the time-averaged health state metrics for the plurality of ordered health states are consistent with ordered health states.

2. The method of claim 1, wherein the test sequence is repeated with the control parameter set to the baseline value at least three times to generate time samples of one or more data parameters to establish reference values of the healthy UUT, wherein said processor declares a reference value for each time sample as that value that minimizes a maximum error between the declared reference value and the established reference values.

3. The method of claim 1, wherein the processor applies a fixed-length moving average filter to the differences between the degraded and references values to determine the time-averaged health state metric.

4. The method of claim 1, wherein the processor applies a variable-length integration filter to the differences between the degraded and references values to determine the time-averaged health state metric.

5. The method of claim 1, wherein the processor time-averages the gaps, said processor determining the time window wherein the time-averaged gaps are consistent with ordered health states.

6. The method of claim 1, wherein the step of determining with the processor the time window comprises selecting the time sample at which the minimum gap between the ordered health states satisfies both a first criteria to ensure order of the health states and second criteria to ensure separation of the health states to determine an end point of a time window for the FTF signature.

7. The method of claim 6, wherein said first criteria comprises exceeding a threshold and said second criteria comprises selection of the maximum minimum gap.

8. The method of claim 6, wherein the step of determining with the processor the time window further comprises selecting a time sample preceding the end point at which the minimum gap satisfies a third criteria to ensure order of the health states to determine a start point of the time window for the FTF signature,

9. The method of claim 8, wherein the third criteria comprises crossing a threshold in a positive going direction.

10. The method of claim 1, wherein the step of determining with the processor the time window comprises:
computing the minimum gap between the ordered health states at each said time sample;
selecting the time sample at which the minimum gap is a maximum to determine an end point of the window;
selecting the first time sample preceding the end point at which the minimum gap crosses a threshold in a positive going direction as a start point of the window.

11. The method of claim 1, further comprising selecting with the processor a fixed-length window from the determined time window in which the gaps between the time-averaged health state metrics for the plurality of ordered health states are the most consistent with ordered health states.

12. The method of claim 1, wherein the test sequence comprises multiple sub-sequences that test difference aspects of the UUT, further comprising overlapping the determined time window with the test sequence and adjusting the boundaries of the time window to align to one or more sub-sequences.

13. The method of claim 1, wherein the processor determines at least one time window for each data parameter in which the gaps between the time-averaged health state metrics for the plurality of ordered health states are consistent with ordered health states, said processor selecting the time window from the data parameter having the largest percentage of positive gaps over the test sequence.

14. The method of claim 1, wherein the processor determines at least one time window for each data parameter in which the gaps between the time-averaged health state metrics for the plurality of ordered health states are consistent with ordered health states, said processor selecting the time window that maximizes the separation of the ordered health state metrics.

15. A method for finding a fault-to-failure (FTF) signature for a unit under test (UUT), comprising:
performing a test sequence with the UUT to generate time samples of one or more data parameters to establish reference values of a healthy UUT;
for each of a plurality of ordered health states, setting a control parameter of the UUT to a different degradation level and repeating the test sequence with the UUT to generate time samples of the one or more data parameters to establish degraded values;
for each said data parameter, computing with a processor,
a time-average health state metric based on differences between the degraded and references values as a function of the time sample over the test sequence for each of the ordered health states; and
gaps between the health state metrics for the ordered health states at the time samples;
a minimum gap from the gaps between the health state metrics; and
selecting with the processor for a data parameter the time sample at which the minimum gap is a maximum to determine an end point of a time window for the FTF signature; and
selecting with the processor the first time sample preceding the end point at which the minimum gap crosses a threshold in a positive going direction to determine a start point of the time window for the FTF signature,
wherein the order of the health state metrics in the FTF signature as defined by the start and end points of its time window is consistent with ordered health states.

16. The method of claim 15, wherein the test sequence is repeated with the control parameter set to the baseline value at least three times to generate time samples of one or more data parameters to establish reference values of the healthy UUT, wherein said processor declares a reference value for each time sample as that value that minimizes a maximum error between the declared reference value and the established reference values.

17. The method of claim 15, wherein the processor determines at least one time window for each data parameter in which the gaps between the time-averaged health state metrics for the plurality of ordered health states are consistent with ordered health states, said processor selecting the time window from the data parameter having the largest percentage of gaps that exceed the threshold over the test sequence.

18. A method for finding a fault-to-failure (FTF) signature for a unit under test (UUT), comprising:
performing a test sequence with the UUT to generate time samples of one or more data parameters to establish reference values of a healthy UUT;
for each of a plurality of ordered health states, setting a control parameter of the UUT to a different degradation level and repeating the test sequence with the UUT to generate time samples of the one or more data parameters to establish degraded values;
for each said data parameter, for each time sample in the test sequence a processor,
computing a distance between the degraded and references values for each of the ordered health states;
applying a fixed-length moving average filter to the distances to compute a time-average health state metric at the time sample for each of the ordered health states;
computing gaps between the time-averaged health state metrics at the time sample for the ordered health states; and
a minimum gap from the gaps between the health state metrics;
selecting with the processor for at least one data parameter the time sample corresponding to the maximum minimum gap to determine an end point of a time window for the FTF signature; and
selecting with the processor the first time sample preceding the end point at which the minimum gap crosses a threshold in a positive going direction to determine a start point of the time window for the FTF signature,
wherein the order of the health state metrics in the FTF signature as defined by the start and end points of its time window is consistent with ordered health states.

19. The method of claim 18, wherein the test sequence is repeated with the control parameter set to the baseline value at least three times to generate time samples of one or more data parameters to establish reference values of the healthy UUT, wherein said processor declares a reference value. for each time sample as that value that minimizes a maximum error between the declared reference value and the established reference values.

20. The method of claim 18, wherein the processor determines at least one time window for each data parameter in which the gaps between the time-averaged health state metrics for the plurality of ordered health states are consistent with ordered health states, said processor selecting the time window from the data parameter having the largest percentage of gaps that exceed the threshold over the test sequence.
